(19) United States
(12) Patent Application Publication
(10) Pub. No.: US 2025/0045571 A1
(43) Pub. Date: Feb. 6, 2025

(54) TIME SERIES PATTERN PREDICTION DEVICE AND METHOD OF OPERATING THE SAME

(71) Applicant: ELECTRONICS AND TELECOMMUNICATIONS RESEARCH INSTITUTE, Daejeon (KR)

(72) Inventor: Byounghwa LEE, Daejeon (KR)

(21) Appl. No.: 18/602,429

(22) Filed: Mar. 12, 2024

(30) Foreign Application Priority Data
Aug. 3, 2023 (KR) 10-2023-0101823

(51) Int. Cl. G06N 3/047; G06N 3/08

(52) U.S. Cl. CPC G06N 3/047; G06N 3/08

(57) ABSTRACT

Disclosed is a time series pattern prediction device, which includes a segment pattern set generation unit that divides time series data into a plurality of segments and generates a segment pattern set based on a plurality of unit patterns corresponding to the plurality of segments, a network generation unit that generates a Bayesian network based on the segment pattern set, and a time series pattern prediction unit that generates a prediction pattern based on the Bayesian network.

### CROSS-REFERENCE TO RELATED APPLICATIONS

This application claims priority under 35 U.S.C. § 119 to Korean Patent Application No. 10-2023-0101823 filed on Aug. 3, 2023, in the Korean Intellectual Property Office, the disclosures of which are incorporated by reference herein in their entireties.

### BACKGROUND

Embodiments of the present disclosure described herein relate to a time series pattern prediction device and a method of operating the same, and more particularly, relate to a time series pattern prediction device that generates prediction patterns of time series data at various scales using a multi-layer Bayesian network.

### (1) Time Series Forecasting

A time series refers to a data format in which data samples are in temporal order. A typical time series has equally spaced points and is therefore discrete-time data. Most time series prediction models are specialized in one-step-ahead prediction, predicting the next step, and models that perform multi-step-ahead prediction are rare. A typical example of the one-step ahead prediction methodology is an ARIMA (autoregressive integrated moving average) model, which traditionally applies specific assumptions such as normality and independent identity distribution to the time series. Traditional time series prediction models such as the ARIMA have limitations in that prediction performance is guaranteed only for time series that satisfy given assumptions and cannot handle outliers.

The multi-step ahead prediction models are divided into two types: the first is a method that directly predicts several future steps at once, and the second is an iterative method that predicts multiple future steps step by step by repeatedly applying a single step prediction. The former has the disadvantage of requiring a large amount of calculation, and the latter has the disadvantage of not having high accuracy of the model due to accumulated errors since the predicted values are fed back as input to make the next prediction.

With the development of deep learning, time series may also be predicted through deep neural network learning methods. Traditionally, there are an RNN (recurrent neural network) and its improved model, an LSTM (long short-term memory), and various models based on it, but they usually have the disadvantage of performing worse than tree-based models (LightGBM, XgBoost, etc.) or being sensitive to hyper-parameter tuning. In contrast, time series prediction using the tree-based model has the disadvantage of requiring a lot of calculations and being prone to overfitting.

### SUMMARY

Embodiments of the present disclosure provide a prediction device and method that may predict different patterns on various time scales at once, from short-term patterns to medium-term patterns and long-term patterns.

Embodiments of the present disclosure provide a prediction device and method capable of predicting patterns by simultaneously considering two or more multiple time series and training the correlation between them to train the values of multiple time series at the same time.

Embodiments of the present disclosure provide a prediction device and method that is transparent and capable of structuring knowledge at a level that humans may easily understand, by generating a Bayesian network with states as nodes and conditional probabilities between multiple states as edges when having a symbolized pattern as a state.

Embodiments of the present disclosure provide a prediction device and method that may effectively train more time series information by also training causal relationships between various time scales through a multi-layer Bayesian network divided into layers according to time scale.

Embodiments of the present disclosure provide a general-purpose prediction device and method that reduces model complexity and may be applied to multiple time series with different numerical value range levels, by predicting symbolic patterns rather than the numerical values of time series data themselves.

According to an embodiment of the present disclosure, a time series pattern prediction device includes a segment pattern set generation unit that divides time series data into a plurality of segments and generates a segment pattern set based on a plurality of unit patterns corresponding to the plurality of segments, a network generation unit that generates a Bayesian network based on the segment pattern set, and a time series pattern prediction unit that generates a prediction pattern based on the Bayesian network.

According to an embodiment, each of the unit patterns may include a symbolized pattern.

According to an embodiment, the segment pattern set may include a first segment pattern set generated based on segments in which the time series data is divided with a first scale having a first time interval, and a second segment pattern set generated based on segments in which the time series data is divided with a second scale having a second time interval, and the Bayesian network may include a multi-layer Bayesian network including a first layer that trains the first segment pattern set and a second layer that trains the second segment pattern set.

According to an embodiment, the second time interval of the second scale may be greater than the first time interval of the first scale.

According to an embodiment, the multi-layer Bayesian network may include an internal edge connecting between nodes included in one of the first layer and the second layer, and an outer edge connecting a node included in the first layer to a node included in the second layer.

According to an embodiment, the time series pattern prediction unit may generate a first prediction pattern for the first scale of the time series data using only the first layer of the multi-Bayesian network.

According to an embodiment, the time series pattern prediction unit may generate a first prediction pattern for the first scale of the time series data and a second prediction pattern for the second scale of the time series data, using the first layer and the second layer of the multi-Bayesian network.

According to an embodiment of the present disclosure, a method of operating a time series pattern prediction device including a segment pattern set generation unit, a network generation unit, and a time series pattern prediction unit, includes dividing, by the segment pattern set generation unit, time series data into a plurality of segments and generating a segment pattern set based on a plurality of unit patterns corresponding to the plurality of segments, generating, by the network generation unit, a Bayesian network based on the segment pattern set, generating, by the time series pattern prediction unit, a prediction pattern based on the Bayesian network.

According to an embodiment, the generating, by the segment pattern set generation unit, of the segment pattern set may include dividing the time series data into the plurality of segments in units of a specific scale, extracting the plurality of unit patterns corresponding to the plurality of segments, extracting a unique pattern from the plurality of unit patterns, and counting duplicate values of the unique pattern from the plurality of unit patterns, and the generating, by the network generation unit, of the Bayesian network based on the segment pattern set may include generating the Bayesian network based on the counted duplicate values with the unique pattern as a node.

According to an embodiment, the generating, by the segment pattern set generation unit, of the segment pattern set may include moving a segment division time of the time series data by a unit step by performing a window sliding.

According to an embodiment, each of the unit patterns may include a symbolized pattern.

According to an embodiment, the segment pattern set may include a first segment pattern set generated based on segments in which the time series data is divided with a first scale having a first time interval, and a second segment pattern set generated based on segments in which the time series data is divided with a second scale having a second time interval, and

The Bayesian network may include a multi-layer Bayesian network including a first layer that trains the first segment pattern set and a second layer that trains the second segment pattern set.

According to an embodiment, the second time interval of the second scale may be greater than the first time interval of the first scale.

According to an embodiment, the multi-layer Bayesian network may include an internal edge connecting between nodes included in one of the first layer and the second layer, and an outer edge connecting a node included in the first layer to a node included in the second layer.

According to an embodiment, the generating, by the time series pattern prediction unit, of the prediction pattern based on the Bayesian network may include generating, by the time series pattern prediction unit, a first prediction pattern for the first scale of the time series data using only the first layer of the multi-layer Bayesian network.

According to an embodiment, the generating, by the time series pattern prediction unit, of the prediction pattern based on the Bayesian network may include generating, by the time series pattern prediction unit, first prediction pattern for the first scale of the time series data and a second prediction pattern for the second scale of the time series data, using the first layer and the second layer of the multi-layer Bayesian network.

According to an embodiment of the present disclosure, a time series pattern prediction system includes a database that stores time series data, and a time series pattern prediction device that generates a prediction pattern based on the time series data, and the time series pattern prediction device includes a segment pattern set generation unit that divides the time series data into a plurality of segments and generates a segment pattern set based on a plurality of unit patterns corresponding to the plurality of segments, a network generation unit that generates a Bayesian network based on the segment pattern set, and a time series pattern prediction unit that generates the prediction pattern based on the Bayesian network.

According to an embodiment, the time series data may include a plurality of time series data, and the segment pattern set may include patterns extracted from each of the plurality of time series data.

According to an embodiment, each of the unit patterns may include a symbolized pattern.

### BRIEF DESCRIPTION OF THE FIGURES

The above and other objects and features of the present disclosure will become apparent by describing in detail embodiments thereof with reference to the accompanying drawings.

FIG. 1 is a diagram illustrating a time series pattern prediction system according to an embodiment of the present disclosure.

FIG. 2 is a block diagram illustrating a time series pattern prediction device of FIG. 1.

FIG. 3 is a flowchart illustrating an operation method of a time series pattern prediction device of FIG. 2.

FIG. 4 is a flowchart illustrating operation S210 of FIG. 3 in detail.

FIG. 5 is a diagram illustrating an example of time series data.

FIG. 6 is a diagram for describing operation S211 of FIG. 4.

FIG. 7 is a diagram for describing operation S212 of FIG. 4.

FIG. 8 is a diagram for describing operation S213 of FIG. 4.

FIG. 9 is a diagram for describing operation S214 of FIG. 4.

FIG. 10 is a diagram for describing operation S215 of FIG. 4.

FIG. 11 is a diagram for describing an operation of a network generation unit of FIG. 2.

### DETAILED DESCRIPTION

### (1-1) Symbolic Time Series Approximation

SAX (Symbolic Aggregate approximation) [1] is a methodology that performs dimensionality reduction on a time series of numeric values into a sequence composed of symbols, by dividing the time series into segments with specific intervals based on a PAA (Piecewise Aggregate Approximation) methodology and symbolizing the values belonging to each segment as one value. However, when the dimensionality reduction is performed, the average value of each segment is set as a representative value, so the shape of the time series becomes stepped, which has the disadvantage of causing a lot of information loss.

[1] Lin, J., Keogh, E., Lonardi, S., & Chiu, B. (2003 June). A symbolic representation of time series, with implications for streaming algorithms. In Proceedings of the 8th ACM SIGMOD workshop on Research issues in data mining and knowledge discovery (pp. 2-11).

### (1-2) SAX Improved Model

To overcome the limitation that existing SAX uses only the average value of each segment as the representative value, there is a TFSAX (Trend Feature Symbolic Aggregate approximation) methodology [2] that incorporates trends (up, down, etc.) of each segment as a feature. However, the TFSAX methodology has limitations as it does not consider various time scales, does not consider multiple time series at once, and is not a methodology that may utilize features graphically like a Bayesian network.

[2] Yu, Yufeng, et al. “A novel trend symbolic aggregate approximation for time series.” arXiv preprint arXiv: 1905.00421 (2019).

### (2) Bayesian Network

The Bayesian network is one of the probabilistic graphical models (PGM) and is a model that uses Bayesian inference to calculate probability. Each node is a random variable and is equivalent to a feature from a data perspective. An edge connecting two nodes represents conditional probability and has directionality. When there is no edge between two nodes, they are in a state of conditional independent. The topology of a Bayesian network is a type of directed acyclic graph (DAG) in which there is directionality and cycles cannot be formed. There is an advantage in being able to infer causal relationships between variables through the Bayesian network, but there is a problem of combinatorial explosion in structure learning that determines the topology. The combinatorial explosion is a problem that occurs since the search space expands exponentially as the number of variables increases, so the number of all cases cannot be counted. However, unlike deep learning models, which are black-box models that cannot describe the inside of the model, it has the advantage of being able to transparently identify the causal relationships between variables. When there is no edge direction, it becomes a Markov Random Field (MRF), which has the disadvantage of making probability calculation and parameter estimation difficult.

The Bayesian network is composed of 1) a structure representing conditional dependencies between variables (structural learning) and 2) a local probability distribution associated with each variable (parameter learning). By combining these two, the joint probability distribution of all variables may be obtained. The fact that there is no connection between two variables means conditional independency. Since the Bayesian network has directionality, the parent node and child node of each node (=variable) may be defined as the departure node and destination node of a directed edge, respectively. When the parent node of a variable X̅ᵢ̅ is called P̅a̅(̅X̅ᵢ̅)̅, the joint probability distribution of the Bayesian network may be expressed as the product of the conditional probability of each variable conditioned on the parent node as follows: P̅(̅X̅₁̅,̅ .̅ .̅ .̅ ,̅ X̅ₙ̅)̅=̅π̅ᵢ̅₌̅₁̅ⁿ̅P̅(̅X̅₁̅|̅P̅a̅(̅X̅₁̅)̅)̅. Parameter learning is done through the maximum likelihood method when the data is completely observed, and is done through an expectation maximization (EM) method when the data is partially observed. In the case of structure learning, there are score-based methods and constraint-based methods. The score-based learning determines the Bayesian network structure through the process of calculating the objective function of the graph and optimizing it, and representative algorithms include K3 (based on greedy search) and ILP (integer linear programming). The constraint-based methods train the Bayesian network structure by evaluating a set of three or more nodes through a conditional independence test, and representative algorithms include Hill-Climbing and Tabu-search.

Hereinafter, embodiments of the present disclosure will be described clearly and in detail such that those skilled in the art may easily carry out the present disclosure.

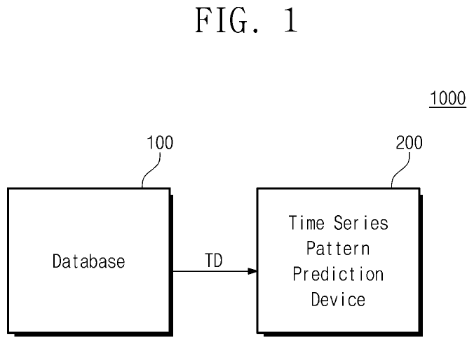

FIG. 1 is a diagram illustrating a time series pattern prediction system according to an embodiment of the present disclosure.

Referring to FIG. 1, a time series pattern prediction system 1000 may include a database 100 and a time series pattern prediction device 200.

The database 100 may be configured to store time series data TD. For example, the time series data TD may be a discrete data format distributed at specific intervals over time. As another example, the time series data TD may have a continuous data format that is continuously distributed over time.

The database 100 may be configured to provide stored time series data TD to the time series pattern prediction device 200.

The time series pattern prediction device 200 may be configured to generate a predicted pattern by predicting a future time series pattern based on the time series data TD. In an embodiment, the time series pattern prediction device 200 may be configured to generate a prediction pattern for each of different interval scales with respect to the time series data TD. In an embodiment, the time series pattern prediction device 200 may be configured to generate a prediction pattern by generating a Bayesian network.

Hereinafter, a detail configuration and operation of the time series pattern prediction device 200 will be described in detail with reference to the drawings.

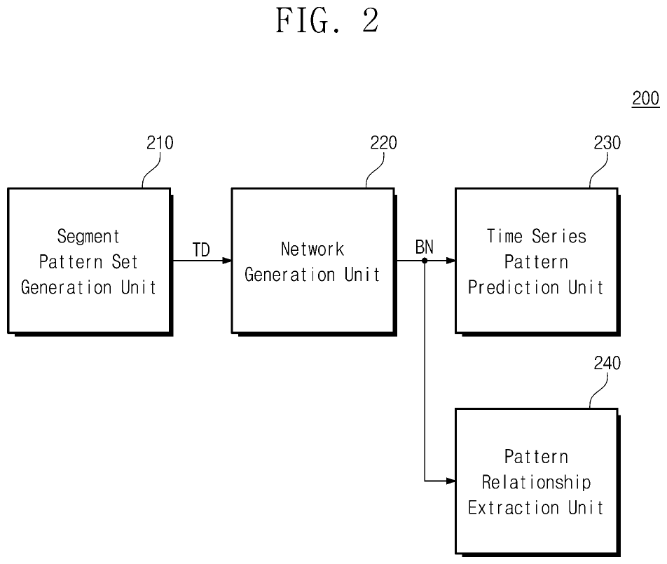

FIG. 2 is a block diagram illustrating a time series pattern prediction device of FIG. 1.

Referring to FIG. 2, the time series pattern prediction device 200 may include a segment pattern set generation unit 210, a network generation unit 220, a time series pattern prediction unit 230, and a pattern relationship extraction unit 240.

The segment pattern set generation unit 210 may be configured to receive the time series data TD. The segment pattern set generation unit 210 may be configured to generate a segment pattern set SPS based on the time series data TD.

The segment pattern set generation unit 210 may be configured to divide the time series data TD into a plurality of segments at specific time intervals, to extract a plurality of unit patterns corresponding to the plurality of segments, and then to generate the segment pattern set SPS based on the plurality of extracted unit patterns. Each unit pattern may include a symbolized pattern.

In the present disclosure, instead of using the numerical value itself of the time series data TD as a node (=state), the segment pattern set SPS may be generated to set a pattern derived from time series values within a segment as the node. When a time series value is set as a state, it is difficult to turn it into knowledge by itself. However, in the case of the present disclosure, when the state is set as a symbolized pattern, it may be made into knowledge by building the Bayesian network that may easily understand the relationships between patterns. In this case, a kind of stylized facts may be extracted and verified, and a transparent white-box model that may be understood by humans may be built. In addition, inferring patterns has the advantage of lowering the complexity of the model and reducing the amount of calculation compared to predicting values.

The segment pattern set generation unit 210 may be configured to generate the plurality of segment pattern sets SPS. The plurality of segment pattern sets SPS may be created by dividing the time series data TD with scales having different time intervals. For example, a first segment pattern set may be generated by extracting unit patterns from segments in which the time series data TD is divided with a first scale having a first time interval, and the second segment pattern set may be generated by extracting unit patterns from a plurality of segments in which the time series data TD is divided with a second scale having a second time interval.

In an embodiment, the second time interval of the second scale may be greater than the first time interval of the first scale. For example, the first time interval may be 10 minutes and the second time interval may be 1 hour.

The time interval of the scale that divides the time series data TD may be set to as many types as a user wants. For example, time series data TD with a length of one year may be cut into four types of time intervals: 1 minute, 1 hour, 1 day, and 1 month. However, the present disclosure is not limited to this, and the plurality of segment pattern sets SPS may be generated by dividing the time series data TD with scales having various time intervals.

In this case, the reason for dividing the time series data TD with scales of specific time intervals is to extract one unit pattern for each segment.

In the present disclosure, the time series data TD may be divided with scales of various time intervals to generate a plurality of segment sets. Accordingly, different patterns may be extracted at various time scales from short term to long term.

In an embodiment, the segment pattern set generation unit 210 may be configured to divide the plurality of time series data TD. For example, when the plurality of time series data TD is divided, the segment pattern set SPS may be expressed in a pattern vector format with patterns extracted from each of the plurality of time series data TD as components.

For example, the k segments corresponding to the i-th layer among N layers may be expressed as a vector of Sᵢ¹, Sᵢ², . . . , Sᵢ^{j}, . . . , Sᵢ^{k}. Here, a j-th segment Sᵢ^{j} is a vector composed of n (=number of time series) time series segment vectors and may be expressed as S̅ᵢ̅^̅{̅j̅}̅=̅(̅X̅ᵢ̅^̅{̅1̅,̅j̅}̅,̅ X̅ᵢ̅^̅{̅2̅,̅j̅}̅,̅ .̅ .̅ .̅ ,̅ S̅ᵢ̅^̅{̅n̅,̅j̅}̅)̅, and where X̅ᵢ̅^̅{̅1̅,̅j̅}̅ means the vector of the j-th segment of the first time series data TD.

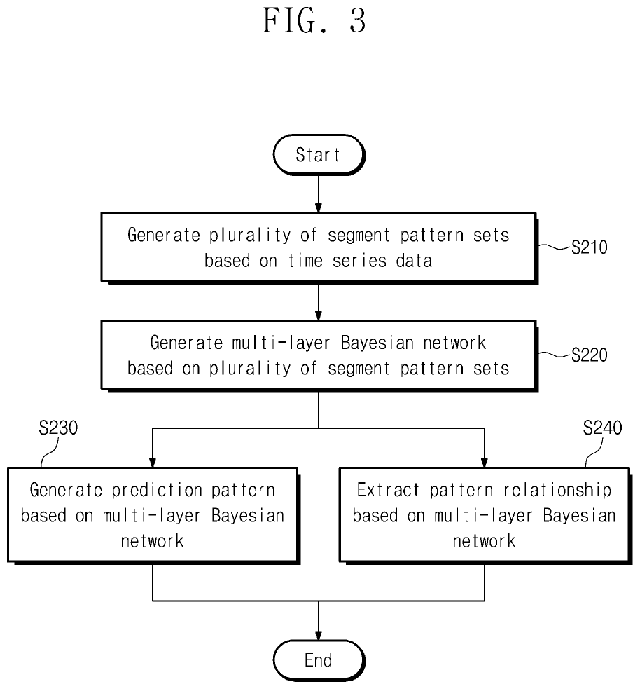

A detail operation of the segment pattern set generation unit 210 will be described later with reference to FIGS. 3 to 10.

The network generation unit 220 may be configured to receive the segment pattern set SPS. The network generation unit 220 may be configured to generate a Bayesian network BN based on the segment pattern set SPS. The Bayesian network BN may be a multi-layer Bayesian network including a plurality of layers. Each layer may include a plurality of nodes. The multi-layer Bayesian network may include internal edges connecting nodes included in one layer and outer edges connecting nodes included in different layers.

The network generation unit 220 may be configured to generate the multi-layer Bayesian network by performing structure learning of the plurality of segment pattern sets SPS with a plurality of layers corresponding thereto. In an embodiment, a plurality of nodes included in each layer of the multi-layer Bayesian network may correspond to a plurality of unit patterns included in the segment pattern set SPS.

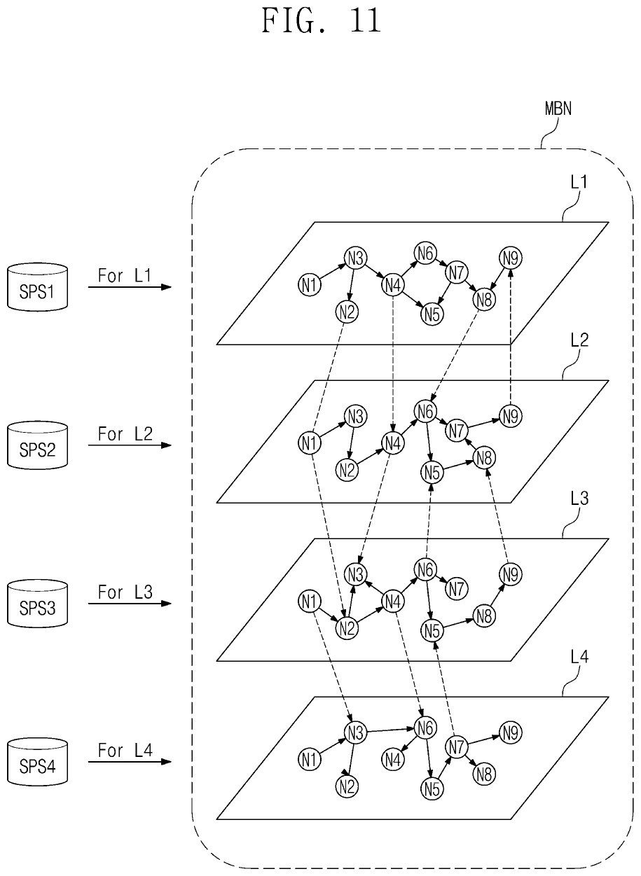

A detailed operation of the network generation unit 220 will be described later with reference to FIGS. 3 and 11.

The time series pattern prediction unit 230 may be configured to generate a prediction pattern based on the Bayesian network BN.

In an embodiment, the time series pattern prediction unit 230 may be configured to generate a plurality of prediction patterns using all layers of the Bayesian network BN. The plurality of prediction patterns may include prediction patterns for a plurality of scales having different time intervals of the time series data TD.

In another embodiment, the time series pattern prediction unit 230 may be configured to generate a specific prediction pattern using a specific layer of the Bayesian network BN. The specific prediction pattern may include a prediction pattern for a scale with a specific time interval of the time series data TD.

The pattern relationship extraction unit 240 may be configured to extract pattern relationships based on the Bayesian network. For example, the pattern relationships may be information about human-level knowledge that humans may understand. Since each node in the Bayesian network is a pattern, the causal relationships between multiple patterns may be transparently identified through edges that express the causal relationships connecting the nodes.

In the case of existing deep neural networks or tree-based machine learning, it is difficult to extract human-level knowledge since it is too complex or the features inside the model are in a form that is difficult for humans to understand (e.g., a black-box model). To solve such problems, explainable AI (XAI, eXplainable AI) is studied, but it has the disadvantage that it is just a post hoc description after model learning is completed and it is difficult to capture causal relationships.

The present disclosure takes advantage of the transparency of Bayesian networks to extract causal relationships between patterns with human-level knowledge, and through this, stylized facts, which are established facts, may be extracted and verified. In addition, rather than simply examining causal relationships with only one time series, causal relationships between the time series may also be made into knowledge by considering multiple time series simultaneously. For example, when a long-term downward pattern in time series ‘A’ actually leads to a mid-term upward pattern in time series ‘B’, in the Bayesian network built through data, an edge will be formed from the long-term pattern node of ‘A’ to the medium-term pattern node of ‘B’. Since this is verified through actual time series data TD, it may be accepted as a stylized fact, and through this, knowledge may be achieved.

FIG. 3 is a flowchart illustrating an operation method of a time series pattern prediction device of FIG. 2. Hereinafter, an operation method of the time series pattern prediction device 200 will be described in detail with reference to FIG. 2.

Referring to FIGS. 2 and 3, in operation S210, the segment pattern set generation unit 210 may generate the plurality of segment pattern sets SPS based on the time series data TD. The plurality of segment pattern sets SPS may be generated by dividing time series data TD with scales having different time intervals.

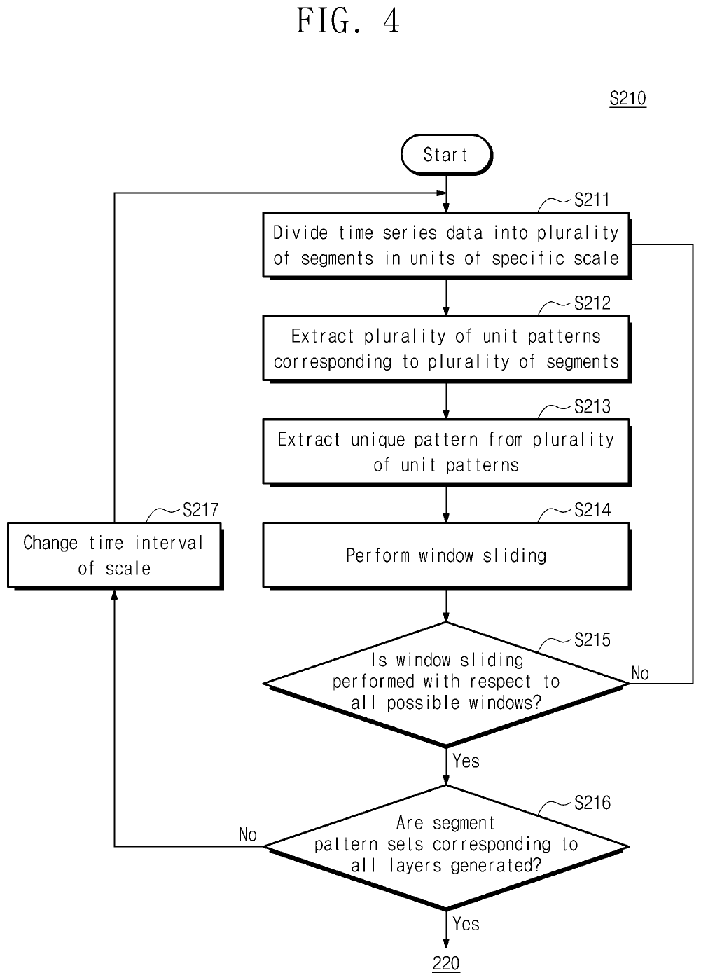

A detail operation of the segment pattern set generation unit 210 that generates the segment pattern sets SPS based on the time series data TD will be described later with reference to FIG. 4.

In operation S220, the network generation unit 220 may generate a Bayesian network based on the segment pattern sets SPS. The Bayesian network may be a multi-layer Bayesian network including a plurality of layers. Each layer may include a plurality of nodes. The multi-layer Bayesian network may include internal edges connecting nodes included in one layer and outer edges connecting nodes included in different layers. Internal edges connecting nodes included in one layer may be related to conditional probabilities between unique patterns for the scale corresponding to each layer. Outer edges connecting nodes included in different layers may be related to conditional probabilities between unique patterns for scales corresponding to different layers.

The multi-layer Bayesian network may be generated by performing structure learning of the plurality of segment pattern sets SPS to a plurality of layers corresponding thereto. A detail operation of the network generation unit 220 will be described later with reference to FIG. 11.

In operation S230, the time series pattern prediction unit 230 may generate a prediction pattern based on the Bayesian network.

In an embodiment, the time series pattern prediction unit 230 may generate a plurality of prediction patterns using all layers of the Bayesian network. The plurality of prediction patterns may include prediction patterns for a plurality of scales having different time intervals of the time series data TD.

In another embodiment, the time series pattern prediction unit 230 may generate a specific prediction pattern using a specific layer of the Bayesian network. The specific prediction pattern may include a prediction pattern for a scale with a specific time interval of the time series data TD.

In operation S240, the pattern relationship extraction unit 240 may extract the pattern relationship based on the Bayesian network. For example, the pattern relationships may be information about human-level knowledge that humans may understand. Since each node in the Bayesian network is a pattern, the causal relationships between multiple patterns may be transparently identified through edges that express the causal relationships connecting the nodes.

FIG. 4 is a flowchart illustrating operation S210 of FIG. 3 in detail.

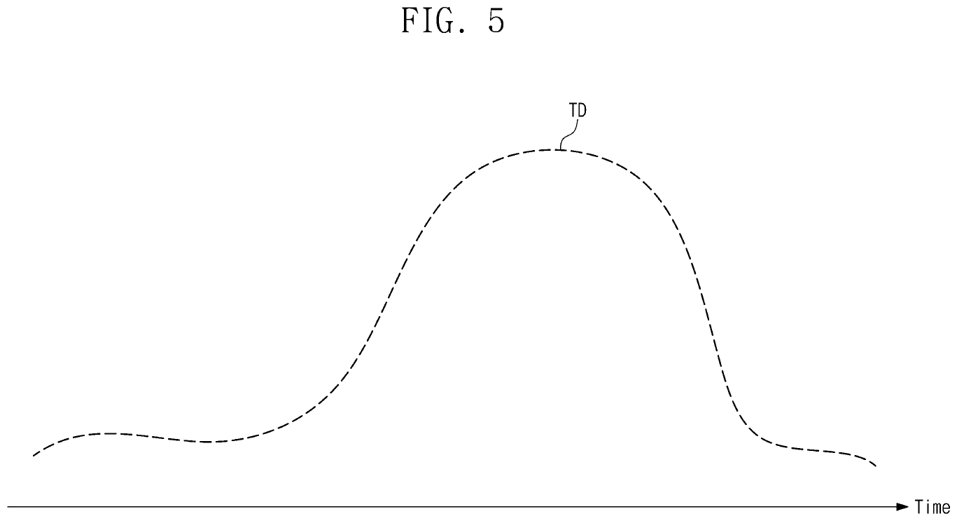

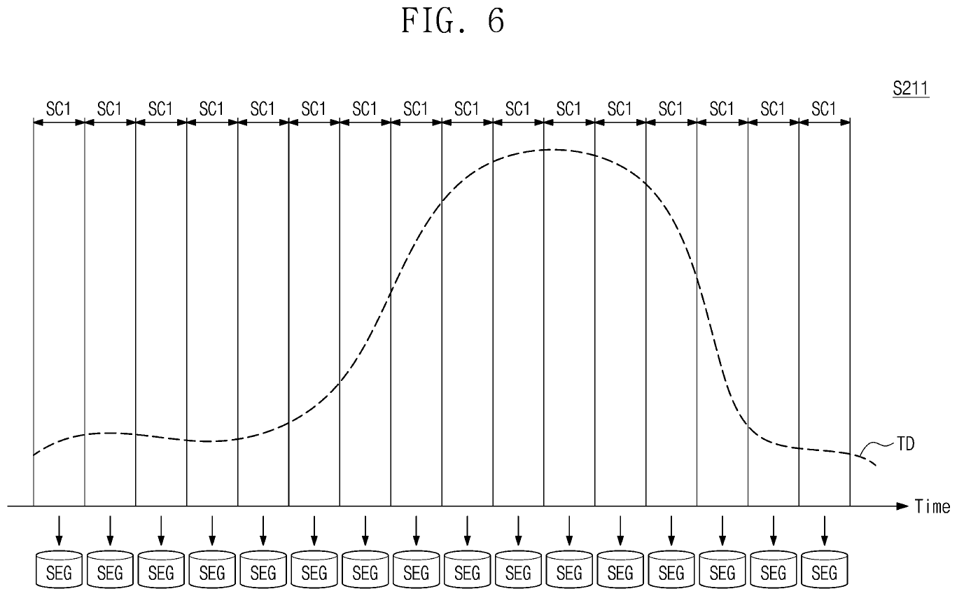

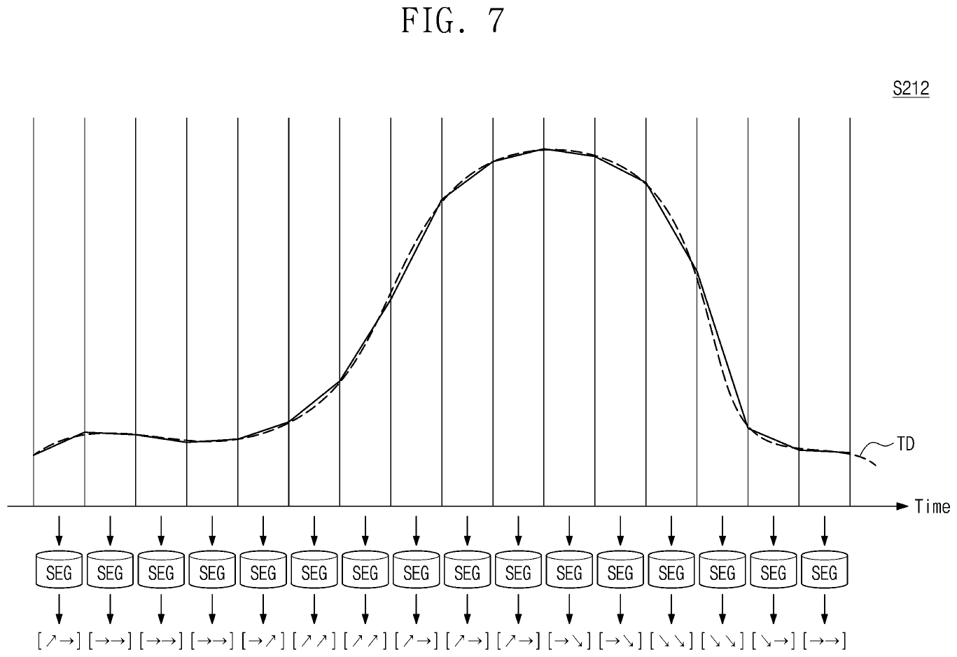

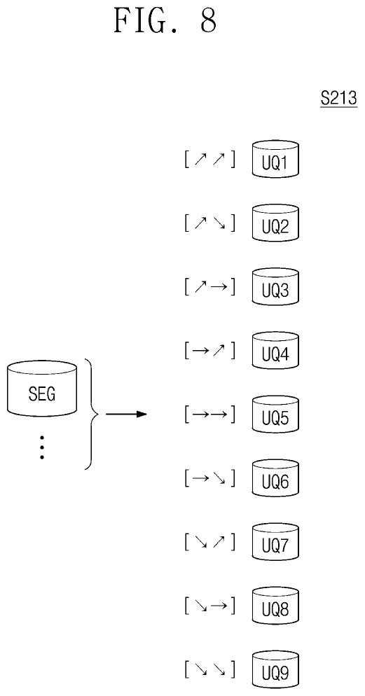

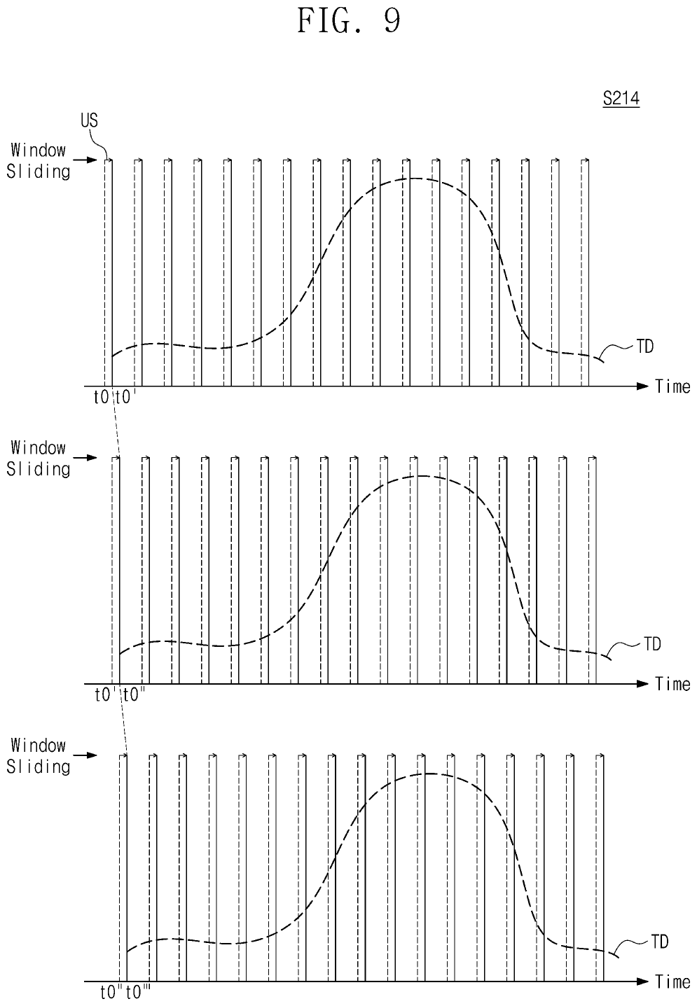

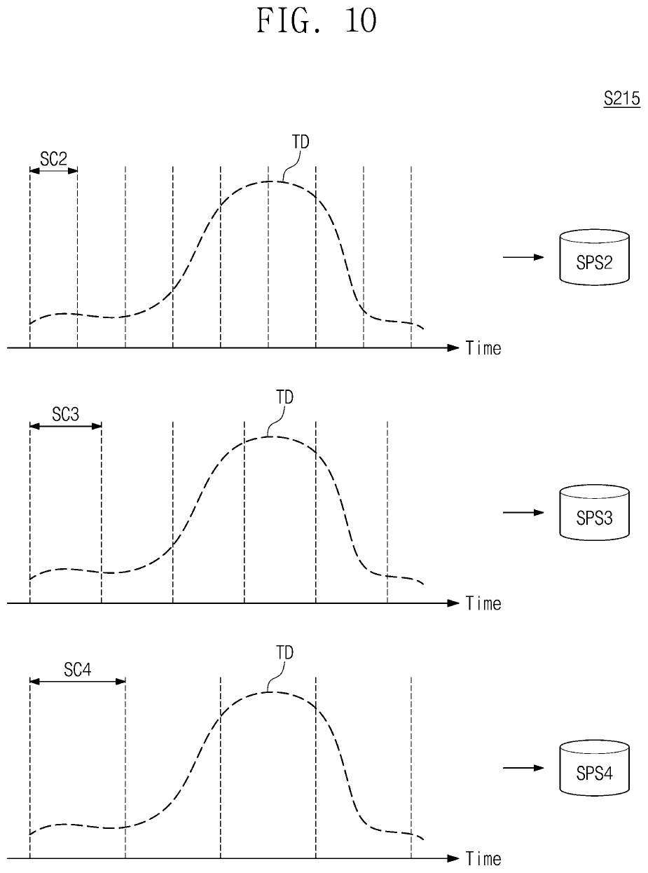

FIG. 5 is a diagram illustrating an example of time series data. FIG. 6 is a diagram for describing operation S211 of FIG. 4. FIG. 7 is a diagram for describing operation S212 of FIG. 4. FIG. 8 is a diagram for describing operation S213 of FIG. 4. FIG. 9 is a diagram for describing operation S214 of FIG. 4. FIG. 10 is a diagram for describing operation S215 of FIG. 4. Hereinafter, an operation method of the segment pattern set generation unit 210 will be described with reference to FIGS. 4 to 10.

Referring to FIGS. 4, 5, and 6, in operation S211, the segment pattern set generation unit 210 may divide the time series data TD as illustrated in FIG. 5 into a plurality of segments SEG in units of a specific scale. For example, the segment pattern set generation unit 210 may generate the plurality of segments SEG by dividing the time series data TD with first scale SC1 units having a first time interval. Each of the plurality of segments SEG may include data of a section divided from the time series data TD.

Referring to FIGS. 4 and 7, in operation S212, the segment pattern set generation unit 210 may extract a plurality of unit patterns corresponding to the plurality of segments SEG.

In an embodiment, the unit pattern may include a symbolized pattern based on the time series value of each segment. For example, the unit pattern may include any one of a rising pattern, a falling pattern, and a flat pattern.

For example, in each segment, when an end value rises by more than 10% compared to a start value, it may be matched to a rising pattern ( [symbol] ) when the end value falls by more than 10% compared to the start value, it may be matched to a falling pattern ( [symbol] ) and the rest may be matched to a flat pattern (→̅).

In an embodiment, the unit pattern may include a combination of two of a rising pattern, a falling pattern, and a flat pattern that allow overlap. For example, the unit pattern may include any one of rise then rise ( [symbol] ) rise then flat ( [symbol] ) rise then fall ( [symbol] ) flat then rise ( [symbol] ) flat then flat (→̅→̅) flat then fall ( [symbol] ) fall then rise ( [symbol] ) fall then flat ( [symbol] ) and fall then fall ( [symbol] ).

However, the patterns are not limited to this, and the type or cardinality of the pattern may be arbitrarily determined by the user. The pattern matching process for unit patterns may use a simple rule-based methodology to match segment time series values and patterns according to a predetermined method, and when a more complex pattern is required, patterns may be matched through machine learning-based methodologies such as a SVM (support vector machine), a Random Forest, and a Gradient Boosting Decision Tree, and may also be matched through deep neural networks.

For example, in segments divided with scales corresponding to a specific i-th layer, the unit pattern of the j-th segment may be expressed as P̅ᵢ̅^̅{̅j̅}̅, and each component may be determined as P̅ᵢ̅^̅{̅j̅}̅=̅(̅f̅(̅X̅ᵢ̅^̅{̅1̅,̅j̅}̅)̅,̅ f̅(̅X̅ᵢ̅^̅{̅2̅,̅j̅}̅)̅,̅ .̅ .̅ .̅ ,̅ f̅(̅X̅ᵢ̅^̅{̅n̅,̅j̅}̅)̅)̅ by applying a function ‘f’ that maps each segment value into one pattern. In this case, the function ‘f’ may be rule-based, machine learning-based, or deep neural network-based, as described above. When the number of segments is ‘k’ in one layer, there may be k pattern vectors as follows: P̅ᵢ̅¹̅,̅ P̅ᵢ̅²̅,̅ .̅ .̅ .̅ ,̅ P̅ᵢ̅^̅{̅k̅}̅ (for i-th layer).

Referring to FIGS. 4 and 8, in operation S213, the segment pattern set generation unit 210 may extract a unique pattern from a plurality of unit patterns and may count duplicate values of the extracted unique pattern. In operation S220 of FIG. 3, the network generation unit 220 may use the unique pattern of the segment pattern set SPS as a node and may generate the Bayesian network based on the duplicate values of the unique pattern.

A unique pattern may be divided into different pattern types that do not overlap among a plurality of unit patterns.

In an embodiment, when there are nine types of unit patterns, as illustrated in FIG. 9, the unique patterns may include first to ninth unique patterns UQ1 to UQ9. For example, the first unique pattern UQ1 may be a rise and then rise ( [symbol] ) the second unique pattern UQ2 may be a rise and then flat ( [symbol] ) the third unique pattern UQ3 may be a rise and then fall ( [symbol] ) the fourth unique pattern UQ4 may be a flat and then rise ( [symbol] ) the fifth unique pattern UQ5 may be a flat and then flat (→̅→̅), the sixth unique pattern UQ6 may be a flat and then fall ( [symbol] ) the seventh unique pattern UQ7 may be a fall and then rise ( [symbol] ) the eighth unique pattern UQ8 may be a fall and then flat ( [symbol] ) and the ninth unique pattern UQ9 may be a fall and then fall ( [symbol] ).

The unique pattern may correspond to a node of the Bayesian network generated in the network generation unit 220 of FIG. 2. When the number of unique patterns in a specific i-th layer is p̅ᵢ̅, the unique patterns may be expressed as follows: P̅ᵢ̅⁽̅¹̅⁾̅,̅ P̅ᵢ̅⁽̅²̅⁾̅,̅ .̅ .̅ .̅ ,̅ P̅ᵢ̅^̅{̅(̅p̅}̅^̅{̅ᵢ̅}̅⁾̅. Here, the parenthesis within the superscript means that it is different from the sequence number of the segment used above, and means that it is the 1st, 2nd, 3rd, and pᵢ-th unique pattern, respectively. In this case, it is always pᵢ≤k.

In an embodiment, the network generation unit 220 may perform the conditional probability calculation of the Bayesian network based on the overlap value of each unique pattern counted by the segment pattern set generation unit 210.

Referring to FIGS. 4 and 9, in operation S214, the segment pattern set generation unit 210 may perform a window sliding to move the segment division time of the time series data TD by a unit step US.

For example, when the time series data TD is divided with a first scale having a time interval of 1 minute, and when the window sliding step is 10 seconds, in a case of a 1 minute scale layer, the existing segments divided such as [0 minutes 0 seconds, 1 minute 0 seconds], [1 minute 0 seconds, 2 minutes 0 seconds], . . . , etc. may be divided into new segments divided such as [0 minutes 10 seconds, 1 minute 10 seconds], [1 minute 10 seconds, 2 minutes 10 seconds], . . . , etc. (The symbols [start time, end time] represent sections).

The interval of the unit step US may be set based on the time interval of the scale. For example, when window sliding tries to perform 10 times, the interval of the unit step US may have a size of 1/10 of the time interval of the scale.

In the present disclosure, by performing the window sliding, segments generated at various division times in one time series data TD may be generated. By using segments at various times rather than at a specific time, the same effect as selecting segments at random may be achieved.

Referring again to FIG. 4, in operation S215, the segment pattern set generation unit 210 may determine whether window sliding is performed with respect to all possible windows.

In an embodiment, the segment pattern set generation unit 210 moves to operation S216 when the segment division time is the same as the division time of the existing divided segment as a result of performing the window sliding, and if not, the process returns to operation S211, and operations S211 to S214 may be performed.

In another embodiment, the segment pattern set generation unit 210 performs the window sliding, and may move to operation S216 even if the segment division time is not completely the same as the division time of the previously divided segment, and even in cases where significant section overlap occurs and the meaning of random sampling fades.

In operation S216, the segment pattern set generation unit 210 may determine whether the segment pattern sets SPS corresponding to all layers of the multi-layer Bayesian network are generated.

When the segment pattern sets SPS corresponding to all layers are not generated, the process may proceed to operation S217. In operation S217, the segment pattern set generation unit 210 may change the time interval of the scale and may move back to operation S211 to perform operations S211 to S215.

When the segment pattern sets SPS corresponding to all layers are generated, the process may proceed to operation S220 of FIG. 3.

Referring to FIG. 10, for example, when the multi-layer Bayesian network generated by the network generation unit 220 is composed of four layers, the segment pattern set generation unit 210 may additionally generate a second segment pattern set SPS2 corresponding to the second layer generated by dividing the time series data TD with a second scale SC2, a third segment pattern set SPS3 corresponding to the third layer generated by dividing the time series data TD with a third scale SC3, and a fourth segment pattern set SPS4 corresponding to the fourth layer generated by dividing the time series data TD with a fourth scale SC4. Afterwards, operation S220 may be performed.

FIG. 11 is a diagram for describing an operation of a network generation unit of FIG. 2.

Referring to FIGS. 2 and 11, the network generation unit 220 may be configured to generate the multi-layer Bayesian network by performing structure learning of each of a plurality of segment pattern sets SPS generated by dividing the time series data TD with different scales in different layers.

For example, the network generation unit 220 may train a first segment pattern set SPS1 generated by dividing the time series data TD with a first scale in a first layer L1, may train a second segment pattern set SPS2 generated by dividing the time series data TD with a second scale in a second layer L2, may train a third segment pattern set SPS3 generated by dividing the time series data TD with a third scale in a third layer L3, and may train a fourth segment pattern set SPS4 generated by dividing the time series data TD with a fourth scale in a fourth layer L4.

The nodes in each layer may correspond to unique patterns of each of the segment pattern sets SPS1 to SPS4.

The network generation unit 220 may determine internal edges connecting nodes in each layer through structure learning of a probabilistic graphical model.

For example, when the Bayesian network is expressed as G̅, G̅ is composed of a set V̅ of nodes and a set Ē of edges: G̅=̅(̅V̅,̅ E̅)̅ The node set is expressed as a set v̅=̅P̅₁̅⁽̅¹̅⁾̅,̅ .̅ .̅ .̅ ,̅ P̅₁̅^̅{̅(̅p̅}̅^̅{̅₁̅}̅⁾̅,̅ P̅₂̅⁽̅¹̅⁾̅,̅ .̅ .̅ .̅ ,̅ P̅₂̅^̅{̅(̅p̅}̅^̅{̅₂̅}̅⁾̅,̅ .̅ .̅ .̅ ,̅ P̅_̅{̅N̅}̅⁽̅¹̅⁾̅,̅ .̅ .̅ .̅ ,̅ P̅_̅{̅N̅}̅^̅{̅(̅p̅}̅^̅{̅_̅{̅N̅}̅}̅⁾̅ of unique patterns that include all layers, and the edge set may be set through structure learning.

The network generation unit 220 may determine outer edges connecting nodes of different layers. For example, the second node of the first layer and the first node of the second layer may be connected through the outer edge.

In an embodiment, when the time series pattern prediction unit 230 of FIG. 2 attempts to predict only at a scale with a specific time interval (e.g., 10 minutes), the prediction may be performed using only the nodes of the layer corresponding to the corresponding scale and the internal edges.

In another embodiment, when the prediction at scales of various time intervals (e.g., 10 minutes, 1 hour, 1 week, etc.) in the time series pattern prediction unit 230 of FIG. 2 are simultaneously attempted, the prediction may be performed using the corresponding layer nodes, the internal edges, and the outer edges.

In this case, since it is the pattern of the next time segment on multiple time scales, patterns from short-term to long-term may be predicted at once. For example, when there are time series values up to 23:59 on Nov. 28, 2022, and the Bayesian network is built through the process described above, the patterns including a short-term pattern for 1-minute of [2022-11-29 00:00, 2022-11-29 00:01], a short to medium term pattern for 1 hour of [2022-11-29 00:00, 2022-11-29 01:00], a medium-term pattern for one day of [2022-11-29, 2022-11-30], a mid-to long-term pattern for one month of [2022-11-29, 2022-12-28], and a long-term pattern for one year of [2022-11-29, 2023-11-28] may be predicted all at once.

According to an embodiment of the present disclosure, different patterns shown at various time interval scales, from short-term patterns to medium-term patterns and long-term patterns may be predicted at once.

According to an embodiment of the present disclosure, patterns may be predicted by simultaneously considering multiple time series data and training correlations between time series.

According to an embodiment of the present disclosure, complex causal relationships between different patterns at various time interval scales of multiple time series data may be trained and predicted through the multi-layer Bayesian network. According to an embodiment of the present disclosure, it is possible to structure the multi-layer Bayesian network into transparent knowledge that humans may understand.

According to an embodiment of the present disclosure, since symbolic patterns are predicted rather than the numeric values of time series data themselves, the complexity of the model is lowered, time complexity is also reduced, and versatility is secured even in the case of time series with different numerical value range levels.

The above description refers to embodiments for implementing the present disclosure. Embodiments in which a design is changed simply or which are easily changed may be included in the present disclosure as well as an embodiment described above. In addition, technologies that are easily changed and implemented by using the above embodiments may be included in the present disclosure. While the present disclosure has been described with reference to embodiments thereof, it will be apparent to those of ordinary skill in the art that various changes and modifications may be made thereto without departing from the spirit and scope of the present disclosure as set forth in the following claims.

As used herein, the term “device” or “unit” refers to any combination of software, firmware and/or hardware configured to provide the functionality described herein. For example, software may be implemented as a software package, code, and/or instruction set or instructions, and hardware, for example, may be implemented by hardwired circuitry, programmable circuitry, state machine circuitry, and/or programmable circuitry. It may contain a single or arbitrary combination or assembly of firmware that stores instructions for use.

What is claimed is:

1. A time series pattern prediction device comprising:
a segment pattern set generation unit configured to divide time series data into a plurality of segments and to generate a segment pattern set based on a plurality of unit patterns corresponding to the plurality of segments;
a network generation unit configured to generate a Bayesian network based on the segment pattern set; and
a time series pattern prediction unit configured to generate a prediction pattern based on the Bayesian network.

2. The time series pattern prediction device of claim 1, wherein each of the unit patterns includes a symbolized pattern.

3. The time series pattern prediction device of claim 1, wherein the segment pattern set includes a first segment pattern set generated based on segments in which the time series data is divided with a first scale having a first time interval, and a second segment pattern set generated based on segments in which the time series data is divided with a second scale having a second time interval, and
wherein the Bayesian network includes a multi-layer Bayesian network including a first layer that trains the first segment pattern set and a second layer that trains the second segment pattern set.

4. The time series pattern prediction device of claim 3, wherein the second time interval of the second scale is greater than the first time interval of the first scale.

5. The time series pattern prediction device of claim 3, wherein the multi-layer Bayesian network includes an internal edge connecting between nodes included in one of the first layer and the second layer, and an outer edge connecting a node included in the first layer to a node included in the second layer.

6. The time series pattern prediction device of claim 5, wherein the time series pattern prediction unit is configured to generate a first prediction pattern for the first scale of the time series data using only the first layer of the multi-Bayesian network.

7. The time series pattern prediction device of claim 5, wherein the time series pattern prediction unit is configured to generate a first prediction pattern for the first scale of the time series data and a second prediction pattern for the second scale of the time series data, using the first layer and the second layer of the multi-Bayesian network.

8. A method of operating a time series pattern prediction device including a segment pattern set generation unit, a network generation unit, and a time series pattern prediction unit, the method comprising:
dividing, by the segment pattern set generation unit, time series data into a plurality of segments and generating a segment pattern set based on a plurality of unit patterns corresponding to the plurality of segments;
generating, by the network generation unit, a Bayesian network based on the segment pattern set;
generating, by the time series pattern prediction unit, a prediction pattern based on the Bayesian network.

9. The method of claim 8, wherein the generating, by the segment pattern set generation unit, of the segment pattern set includes:
dividing the time series data into the plurality of segments in units of a specific scale;
extracting the plurality of unit patterns corresponding to the plurality of segments;
extracting a unique pattern from the plurality of unit patterns; and
counting duplicate values of the unique pattern from the plurality of unit patterns, and
wherein the generating, by the network generation unit, of the Bayesian network based on the segment pattern set includes generating the Bayesian network based on the counted duplicate values with the unique pattern as a node.

10. The method of claim 9, wherein the generating, by the segment pattern set generation unit, of the segment pattern set includes:
moving a segment division time of the time series data by a unit step by performing a window sliding.

11. The method of claim 8, wherein each of the unit patterns includes a symbolized pattern.

12. The method of claim 8, wherein the segment pattern set includes a first segment pattern set generated based on segments in which the time series data is divided with a first scale having a first time interval, and a second segment pattern set generated based on segments in which the time series data is divided with a second scale having a second time interval, and
wherein the Bayesian network includes a multi-layer Bayesian network including a first layer that trains the first segment pattern set and a second layer that trains the second segment pattern set.

13. The method of claim 12, wherein the second time interval of the second scale is greater than the first time interval of the first scale.

14. The method of claim 13, wherein the multi-layer Bayesian network includes an internal edge connecting between nodes included in one of the first layer and the second layer, and an outer edge connecting a node included in the first layer to a node included in the second layer.

15. The method of claim 8, wherein the generating, by the time series pattern prediction unit, of the prediction pattern based on the Bayesian network includes generating, by the time series pattern prediction unit, a first prediction pattern for the first scale of the time series data using only the first layer of the multi-Bayesian network.

16. The method of claim 8, wherein the generating, by the time series pattern prediction unit, of the prediction pattern based on the Bayesian network includes generating, by the time series pattern prediction unit, first prediction pattern for the first scale of the time series data and a second prediction pattern for the second scale of the time series data, using the first layer and the second layer of the multi-Bayesian network.

17. A time series pattern prediction system comprising:
a database configured to store time series data; and
a time series pattern prediction device configured to generate a prediction pattern based on the time series data, and
wherein the time series pattern prediction device includes:
a segment pattern set generation unit configured to divide the time series data into a plurality of segments and to generate a segment pattern set based on a plurality of unit patterns corresponding to the plurality of segments;
a network generation unit configured to generate a Bayesian network based on the segment pattern set; and
a time series pattern prediction unit configured to generate the prediction pattern based on the Bayesian network.

18. The time series pattern prediction system of claim 17, wherein the time series data includes a plurality of time series data, and
wherein the segment pattern set includes patterns extracted from each of the plurality of time series data.

19. The time series pattern prediction system of claim 17, wherein each of the unit patterns includes system symbolized pattern.
